(19) United States
(12) Patent Application Publication
(10) Pub. No.: US 2010/0019514 A1
(43) Pub. Date: Jan. 28, 2010

(54) COMPONENT ASSEMBLY WITH A RETAINING FUNCTION, HOLDING-OPEN SYSTEM AND METHOD FOR THE OPERATION THEREOF

(75) Inventor: Herbert Steinwender, Tobelbad (AT)

Correspondence Address: HARNESS, DICKEY & PIERCE, P.L.C., P.O. BOX 828, BLOOMFIELD HILLS, MI, 48303, US

(73) Assignee: Magna Powertrain AG & Co KG, Lannach (AT)

(21) Appl. No.: 12/377,299

(22) PCT Filed: Jul. 31, 2007
(86) PCT No.: PCT/EP07/06767

§ 371 Date: Feb. 12, 2009

(30) Foreign Application Priority Data
Aug. 14, 2006 (DE) 10 2006 037 992.6

(51) Int. Cl. E05C 17/56; E05C 17/02

(52) U.S. Cl. 292/251.5

(57) ABSTRACT

The invention relates to a component (10) with a retaining function, comprising at least one first element (16) and at least one second element (26) which are arranged movably with respect to each other, at least one magnetizable component (18) with residual properties, a magneto-rheological fluid (38) or magnetic powder which is located in the magnetic field of the at least one magnetizable component, when the latter is magnetized, and via which the two elements can be brought into operative connection, and a coil (20) which is arranged in such a manner that, when energized, it can generate a magnetic field sufficient to magnetize the at least one magnetizable component, wherein the coil and the at least one magnetizable component are arranged in such a manner that a first currentless or energized state can be generated, sufficient so as to maintain the operative connection, and a second currentless state can be generated, as a result of which the operative connection can be undone. The invention furthermore relates to a holding-open system with a component of this type and to a method for operating a component of this type and a holding-open system of this type.

The invention relates to a component assembly with a holding function, having at least one first element and at least one second element which are arranged movably with respect to one another and which can be brought into operational connection with one another via a magnetorheological fluid or a magnetic powder. The invention furthermore relates to a method for the operation of such a component assembly, to a holding-open system having such a component assembly and to a method for the operation of such a holding-open system.

Magnetic clutches or brakes are realized using magnetorheological fluids or magnetic powders. Two elements are connected via the magnetorheological fluid or the magnetic powder. The viscosity of the magnetorheological fluid or the magnetic powder solidifies due to an outer magnetic field so that the two elements come into solid operational connection. If the element is, for example, a rotor and if the other element is a stator, a brake can be realized in this manner. If e.g. both elements are rotatably supported, it is a case of a clutch.

DE 100 29 227 A1 shows a controllable braking system in which a magnetic field is constantly maintained with the help of a permanent magnet at the location of the magnetorheological fluid. There is accordingly always an operational connection between two elements. To cancel this operational connection, a coil is provided which generates a counter-field to the permanent magnetic field with a flow of current. To neutralize the magnetic field of the permanent magnet, sufficiently large magnetic fields and in this respect voluminous or weighty coils are required.

The known system serves, for example, as a controllable braking system, in particular for a hinge system for the rotatable and brakable fastening of a vehicle door. Applying the magnetic counter-field to the magnetorheological fluid for the neutralization of the magnetic field of the permanent magnet allows a mutual movement of the elements. In the open state of the vehicle door, the with a flow of current to the coil can be interrupted so that the magnetic field of the permanent magnet is applied to the magnetorheological fluid at fall strength. This hardens and holds the vehicle door in the open state. To close the vehicle door, the counter-field is again generated using the coil so that the magnetic effect of the permanent magnet is neutralized. The magnetorheological fluid liquefies so that the two elements are freely rotatable with respect to one another. The vehicle door can be closed.

On a failure of the onboard power system, the field of the permanent magnet is generally fully effective at the location of the magnetorheological fluid in the known solution and holds said fluid in the solid state. In such a case, the two elements cannot be moved with respect to one another. The vehicle door can in particular not be opened. There is therefore, for example, a safety risk in the event of an accident.

Other solutions dispense with the use of a permanent magnet. A coil is provided with which a magnetic field can be generated which acts at the location of the magnetorheological fluid. A hardening of the magnetorheological fluid so that the first element and the second element are in operational connection with one another is therefore only present when the coil has a with a flow of current. To realize a holding function, for example to hold a vehicle door open, the coil must have a permanent with a flow of current.

It is the object of the present invention to provide a component assembly with a holding function, a holding-open system and a method for the operation of such a component assembly which have a simple and cost-effective design and which allow a secure operation.

This object is satisfied using a component assembly with a holding function having the features of claim 1, a holding-open system having the features of claim 12 and a method having the features of claim 15. Advantageous aspects form the subject of the dependent claims.

A component assembly in accordance with the invention with a holding function has at least one first element and at least one second element which are arranged movably with respect to one another. At least one magnetizable component having magnetic remanence, i.e. with degradable residual magnetism, is provided. The component assembly includes a magnetorheological medium (magnetorheological fluid or magnetic powder) which is located in the magnetic field of the at least one magnetizable component when it is magnetized. Magnetorheological fluids are characterized in that their viscosity increases in a magnetic field, which can in particular result in a hardening of the magnetorheological fluid. If the magnetizable component is magnetized, the magnetorheological fluid accordingly has an increased viscosity or is hardened so that the two elements are in operational connection with one another, i.e. the two elements are mechanically coupled.

For example, with a rotatable support of the one element with respect to the other element, a torque can be transmitted via this operational connection.

Instead of a magnetorheological fluid, a magnetic powder can also be used which is located in the magnetic field of the at least one magnetizable component when it is magnetized. If a magnetic field is present at the location of the magnetic powder due to the magnetization of the magnetizable component, said magnetic powder has become solid and provides an operational connection between the first element and the second element.

The component assembly in accordance with the invention furthermore has a coil which can generate a magnetic field for the sufficient magnetization of the at least one magnetizable component on a current flow to it. The coil and a control device associated with the coil are therefore made to actively change the magnetization state of the magnetizable component, i.e. to actively magnetize or demagnetize the magnetizable component. Unlike in the use of a permanent magnetic element as described in DE 100 29 227 A1, for example, not only a temporary superimposition of an external magnetic field thus takes place via the magnetic field generated by a permanent magnet. Instead, the coil and a control device associated with the coil are made to selectively set such a flow of current to the coil that a magnetization or an at least partial demagnetization of the magnetizable component takes place. A magnetization of the magnetizable component set in this manner can also be maintained in a currentless state of the coil or with a flow of current to the coil with a reduced current strength (relative to the current strength for the magnetization of the magnetizable component) takes place in addition to the thus set magnetization of the magnetizable component until the magnetization is again actively changed by a corresponding change of the with a flow of current to the coil.

The magnetizable component and the coil are therefore arranged and designed such that a first currentless state or current flow state of the coil can be generated in which the magnetizable component provides a magnetic field after its magnetization in which the magnetorheological fluid or the magnetic powder has such a sufficiently solid structure that it maintains an operational connection between the first element and the second element. A magnetic field which magnetizes the magnetizable component is first generated using the coil. The magnetic field thereby arising at the location of the magnetorheological fluid or of the magnetic powder increases the viscosity or hardens the magnetorheological fluid or the magnetic powder. After the switching off or reducing of the current in the coil and of the external magnetic field thus generated, the magnetic field brought about by the magnetizable component remains due to the remanent magnetization. It is in particular possible only to greatly reduce the strength of the electrical current conducted through the coil instead of a complete switching off of the coil current. A stronger operational connection between the first element and the second element is hereby set with a small energy consumption than with a current strength of zero.

Materials having high saturation remanence are particularly suitable for the magnetizable component so that a large magnetic field remains even without application of an external magnetic field.

It is therefore also possible realize the holding function with the component assembly in accordance with the invention without current because the magnetic field is maintained by the magnetizable component at the location of the magnetorheological fluid or of the magnetic powder.

The component assembly in accordance with the invention is moreover designed such that a second currentless state of the coil can be generated in which the magnetizable component is substantially demagnetized, whereby the operational connection between the first element and the second element can be cancelled. Unlike the use, for example, of a permanent magnet, a currentless state is therefore also possible here in which the magnetorheological fluid or the magnetic powder are not hardened and a substantially free movement of the two elements with respect to one another is possible. Since the magnetizable component is made magnetically remanent and since the hysteresis loop of the magnetizable component thus has a certain width which cannot be neglected, the magnetizable component is actively demagnetized by a corresponding with a flow of current to the coil on the basis of an associated control device before the coil is switched to currentless. To achieve a demagnetization which is as complete as possible on the use of a small coil and a small current strength, materials are of advantage with a small coercive force, that is with a small hysteresis curve, compared with a permanent magnet.

If, for example, a vehicle door is realized with the component assembly in accordance with the invention, a particularly reliable solution is present. With a closed vehicle door, the second currentless state is generated in which the magnetizable component is substantially demagnetized. The door is held in a manner known per se by the lock catch. On the failure of the onboard network, for example on an accident, nothing changes in the magnetically generated operational connection. The door can be opened without hindrance.

It is therefore possible using the component assembly in accordance with the invention to maintain both a state currentless or with only a small with a flow of current to the coil in which the magnetorheological fluid or the magnetic powder are exposed to a magnetic field and a state currentless in which no magnetic field is present. A particularly economic and secure operation is possible.

The component assembly in accordance with the invention is connected or connectable to a power supply which can provide a current which can serve for the generation of a magnetic field with the coil sufficient for the magnetization of the magnetizable component. In a preferred embodiment, this power supply is connected to a control device which allows a with a flow of current to the coil for the generation of a magnetic alternating field with a strength reducing over time. An automatic demagnetization of the magnetizable component is almost completely possible using such a control device by application of an alternating field of reducing strength.

The component assembly in accordance with the invention can include a second element, for example, which is supported rotatably or pivotably relative to the first element. A brake can, for example, be realized using such a component assembly. Such a component assembly can, for example, be used in a door or flap, in particular of a motor vehicle. After the opening of the door (with a currentless coil), the magnetizable component is magnetized with the help of the coil and the magnetorheological fluid or the magnetic powder harden, with a with a flow of current to the coil only being necessary for the generation of the magnetic field required for the magnetization of the magnetizable component for a short time and being switched off or at least considerably reduced thereafter. A magnetic field is also maintained after the termination or reduction of the with a flow of current to the coil due to the magnetization of the magnetic component, the magnetorheological fluid or the magnetic powder remain solid and the door is kept open. Before the closing of the door, the magnetic field active in the magnetorheological medium is initially cancelled by continuous with a flow of current to the coil with a DC current in that the coercive field strength corresponding to the magnetizable component is generated by means of the coil such that the magnetorheological fluid or the magnetic powder is no longer solid and does not stand in the way of the closing movement of the door. In the course of the closing movement of the door, a comparatively small magnetic field can optionally be generated at the location of the magnetorheological medium by a corresponding with a flow of current to the coil such that the fluid or magnetic powder effects a damped closing or moving procedure.

In the closed state of the vehicle door, a very largely complete demagnetization of the magnetizable component is carried out by a corresponding with a flow of current to the coil (generation of a magnetic alternating field with a strength reducing over time) in order also no longer to impede a subsequent opening of the door with a coil now not having any flow of current. Alternatively, the complete demagnetization of the magnetizable component can already be carried out before the start o the closing movement, that is without any intermediate flow of DC current to the coil.

With a suitable design, the component assembly in accordance with the invention can also be used directly as a hinge of a door or flap.

Both elements are rotatably supported with a clutch. After the magnetization of the magnetizable component, the magnetized component maintains a sufficient magnetic field at the location of the magnetorheological fluid or of the magnetic powder so that a torque transmission is possible between the two elements. After the magnetization, a further power supply is no longer necessary since the magnetic field is maintained by the magnetized component.

In other designs of the component assembly in accordance with the invention, the first element and the second element are arranged displaceably, in particular linearly displaceably, with respect to one another. The one element, for example, moves in the magnetorheological fluid which is received in the other element. Generating a sufficient magnetic field magnetizes the magnetizable component. A magnetic field which acts at the location of the magnetorheological fluid and hardens it also remains after the switching off of the external magnetic field on the basis of the magnetized component. The two elements can no longer be displaced relative to one another. With a suitable arrangement, a door stopper function can likewise be realized using such a component assembly.

In an embodiment, the magnetorheological fluid or the magnetic powder is located between the first element and the second element which in this respect form the vessel for the fluid or for the powder.

In another embodiment the vessel for the magnetorheological fluid or the magnetic field is formed by one of the elements and the other element dips into the magnetorheological fluid or into the magnetic powder, at least partly. Hardening the magnetorheological fluid or the magnetic powder with the help of the magnetic field of the magnetized component holds the second element in the first element so that the two elements are in operational connection with one another.

In such an embodiment, it is in particular advantageous if the first element, which also serves as a vessel for the magnetorheological fluid or for the magnetic powder, includes the at least one magnetizable component, that is, it is in particular manufactured from the magnetizable material.

In other embodiments, the second element or both elements can comprise the magnetizable material and can in this respect include the magnetizable component.

With respect to the remanence properties of the magnetizable component, it is preferred if the magnetizable component has a coercive field strength in the range from approx. 10³ to 10⁴ A/m. That magnetic field strength is called the coercive field strength (customary abbreviation: H_{K} or H_{C}) for which—starting from a saturation magnetization of the magnetizable component after a complete magnetization—a magnetic induction (customary abbreviation: B; unit T=tesla) or a magnetization (M) of zero results.

It is furthermore preferred if the magnetizable component has a saturation remanence in the range from approx. 0.5 to 2 T (tesla). That magnetic induction is called the saturation remanence (customary abbreviation: BR) which—starting from a saturation magnetization of the magnetizable component which is still present after a complete demagnetization—is still present when the magnetic field applied from the outside is reduced to a field strength of zero (H=0).

It is particularly advantageous if the magnetizable component has a coercive field strength in the range from approximately 10³ to 10⁴ A/m and at the same time a saturation remanence in the range of approximately 0.5 to 2 T. In this case, the magnetizable component, on the one hand—unlike a permanent magnet—is magnetically soft (comparatively small coercive field strength) so that the coil required for the desired magnetization and demagnetization can be dimensioned correspondingly small and small current strengths can be used. The hysteresis loop of the magnetizable component is therefore smaller than with a permanent magnet. On the other hand, a saturation remanence of approximately 0.5 to 2 T means a comparatively strong magnetic field and thus an advantageously strong operational connection between the first element and the second element even in the currentless state or with only a small with a flow of current to the coil. Even with a great steepness of the hysteresis loop, this ultimately means that the material has to have a certain width of the hysteresis loop or a certain coercive field strength, as specified above.

A holding-open system in accordance with the invention has a component assembly in accordance with the invention and serves for a door or a flap, in particular in automobiles. The door or flap is pivotally connected to a holder fixed relative to the door or flap. Either the first element or the second element of the component assembly in accordance with the invention move at least indirectly—for example via an interposed transmission—with the door or with the flap, while the other elements is fastened to the fixed holder.

In particular with a holding-open system with a component assembly in which the first element serves for the holding of the magnetorheological fluid or of the magnetic powder and the second element dips at least partly into the magnetorheological fluid or into the magnetic powder, it is particularly simple if the first element is arranged at the fixed holder.

A particularly compact arrangement is possible when the component assembly in accordance with the invention does not represent an additional element, but is rather used as a hinge, which is in particular possible when the component assembly in accordance with the invention is a component assembly in which the first element and the second element are pivotable with respect to one another.

In a method in accordance with the invention for the operation of a component assembly in accordance with the invention or of a holding-open system in accordance with the invention, a first relative position of the first element and of the second element relative to one another is selected. This can, for example, be an open door or flap. The coil has a flow of current so that a magnetic field is generated which is sufficient for the magnetization of the magnetizable component. Due to the magnetization of the magnetizable component, there is a magnetic field at the location of the magnetorheological fluid or of the magnetic powder which is sufficient for the increase of the viscosity or the hardening of the magnetorheological fluid or of the magnetic powder. The magnetization of the magnetic component is also maintained on the basis of the remanent properties after switching off or reducing the external magnetic field, that is after the switching off or reducing of the current. The viscosity of the magnetorheological fluid remains increased and the magnetorheological fluid or the magnetic powder remains solid. The holding function is therefore also maintained after the switching of or reduction of the current. The two element remain in operational connection with one another. A door is kept open, for example.

In a particularly preferred aspect of the method in accordance with the invention this state can be cancelled again by a with a flow of current to the coil with an alternating current of a strength reducing over time. A magnetic field of reducing strength which successively results in demagnetization is applied to the magnetizable component by such a flow of current. After the demagnetization of the magnetizable component, it no longer generates any magnetic field at the location of the magnetorheological fluid or of the magnetic powder. The magnetorheological fluid or the magnetic powder are no longer solid and a free movement is possible between the first element and the second element. A second relative position can now be set, for example, a vehicle door can be closed.

In another aspect which can in particular be used with doors or flaps, the door is closed against the force of the solid fluid or powder by physical force without previously demagnetizing the magnetizable component. The solid fluid or magnetic powder in this manner allows a damped closing or movement procedure. In the closed state, the demagnetization is then carried out as described in order no longer to impede an opening of the door.

The component assembly in accordance with the invention, the holding-open system in accordance with the invention and the method in accordance with the invention are in particular characterized in that the two extreme states can be maintained currentless. After the magnetization of the magnetizable component, it also maintains the magnetic field when the magnetizing external magnetic field is switched off. A vehicle door is, for example, kept open. After the demagnetization, the movement of the two elements with respect to one another is free since no magnetic field is effective at the magnetorheological fluid or at the magnetic powder. This state can also be maintained currentless with the component assembly in accordance with the invention, with the holding-open system in accordance with the invention and with the method in accordance with the invention. The system in accordance with the invention or the method in accordance with the invention has the advantage with respect to a known solution using a permanent magnet that no large coils are required to generate a counter-field opposite to the magnetic field of the permanent magnet. The system in accordance with the invention or the method in accordance with the invention has the advantage with respect to a known solution in which the magnetic field for the hardening of the magnetorheological fluid or of the magnetic powder is generated only with the help of a coil that no permanent with a flow of current is required to maintain a state.

The invention will be explained in detail with reference to the enclosed Figures which show different embodiments of component assemblies in accordance with the invention in a schematic representation. There are shown:

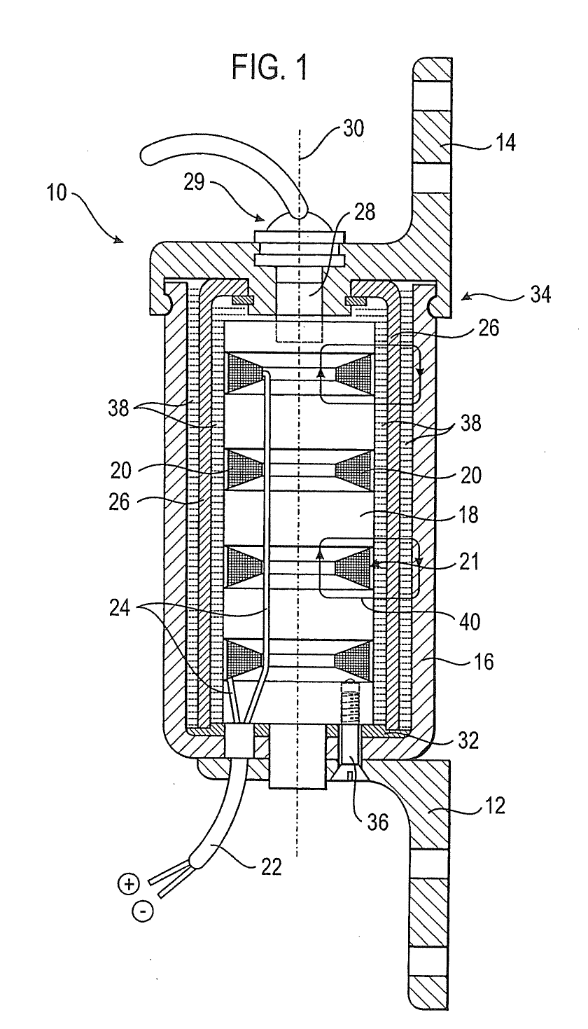

FIG. 1 a lateral sectional view of a first embodiment of a component assembly in accordance with the invention;

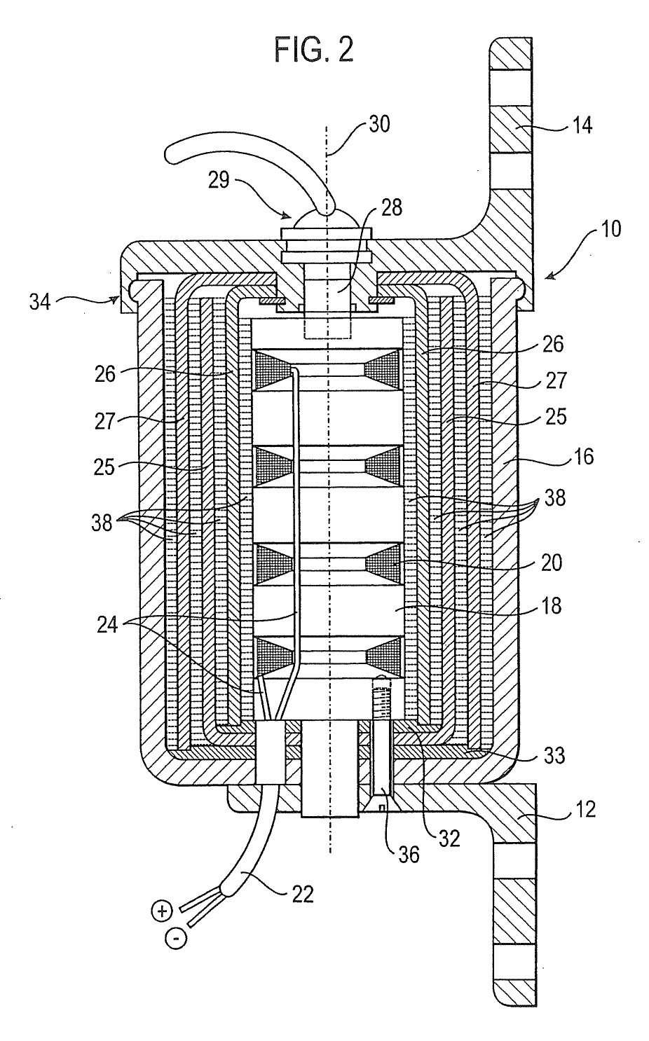

FIG. 2 a lateral sectional view of a second embodiment of a component assembly in accordance with the invention;

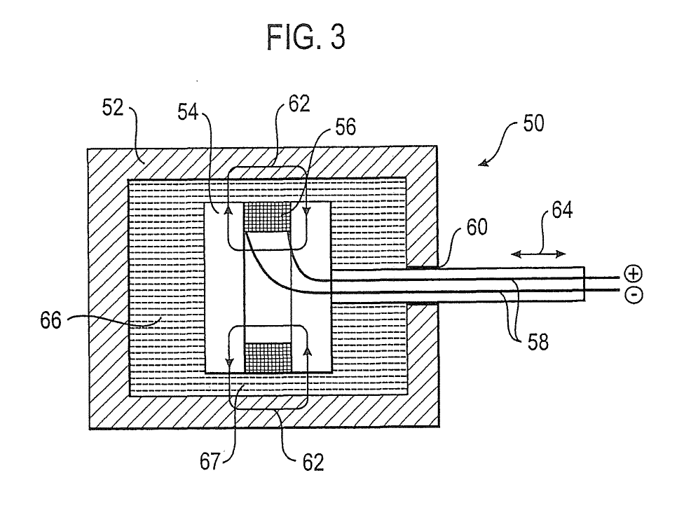

FIG. 3 a lateral sectional view of a third embodiment of a component assembly in accordance with the invention;

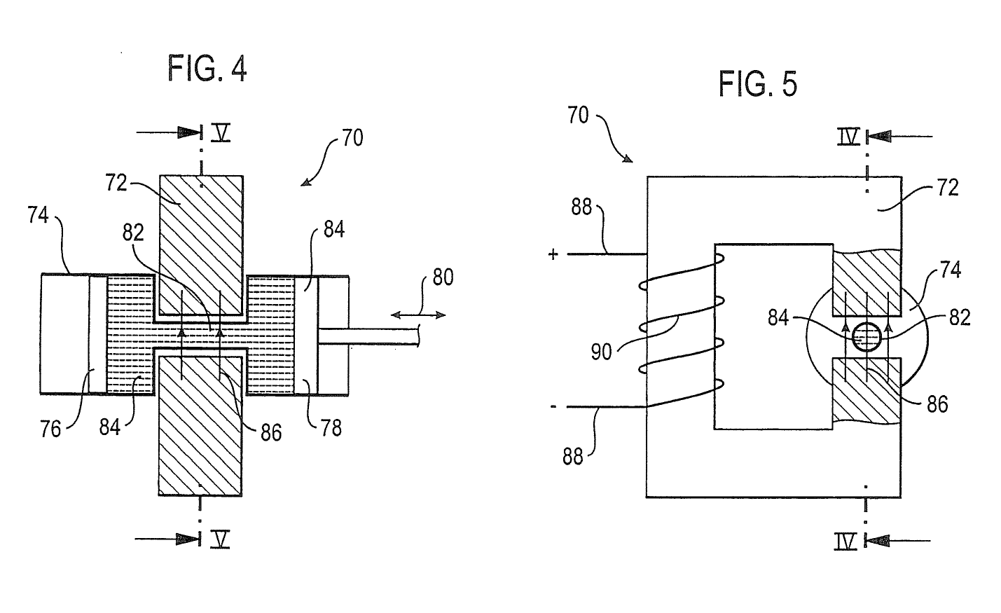

FIG. 4 a sectional view of a fourth embodiment of a component assembly in accordance with the invention;

FIG. 5 a sectional view of the fourth embodiment in the direction of view V, as is indicated in FIG. 4;

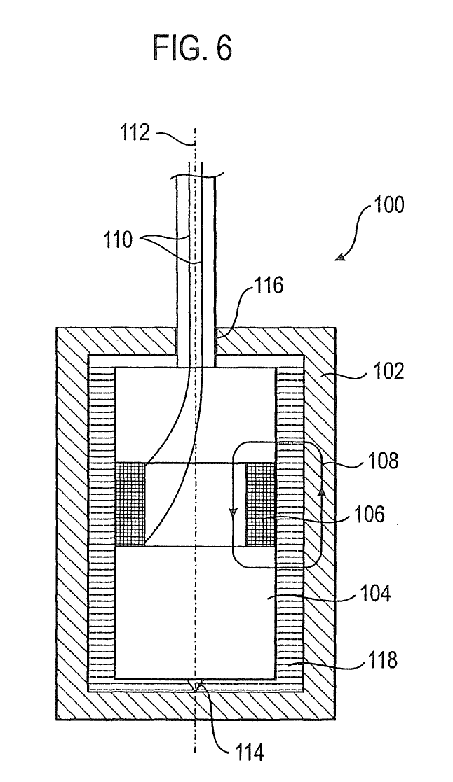

FIG. 6 a lateral sectional view of a fifth embodiment of a component assembly in accordance with the invention;

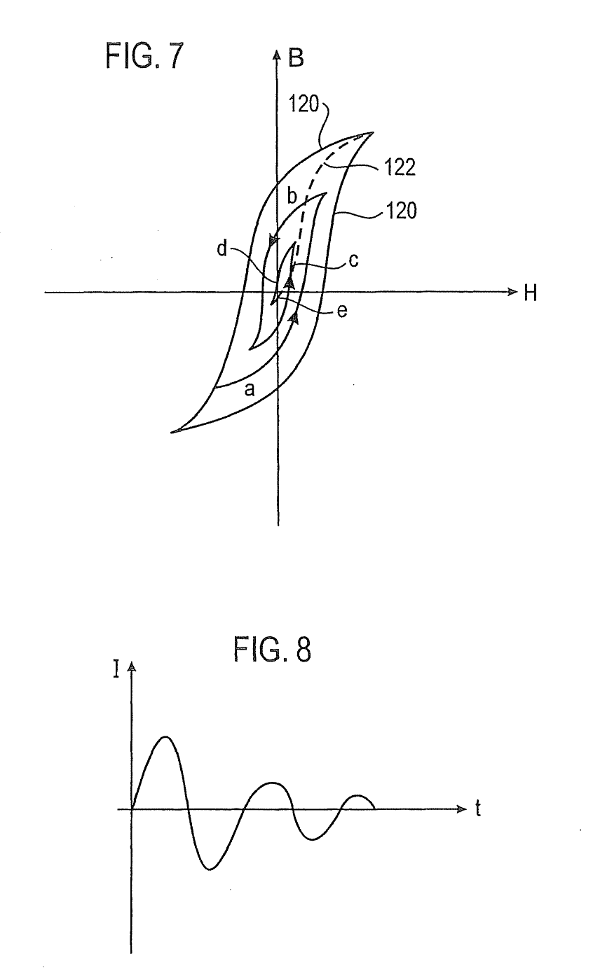

FIG. 7 a diagram of the magnetization with respect to the external magnetic field for explanation;

FIG. 8 a diagram for the indication of the current with respect to time of a coil of a component assembly in accordance with the invention;

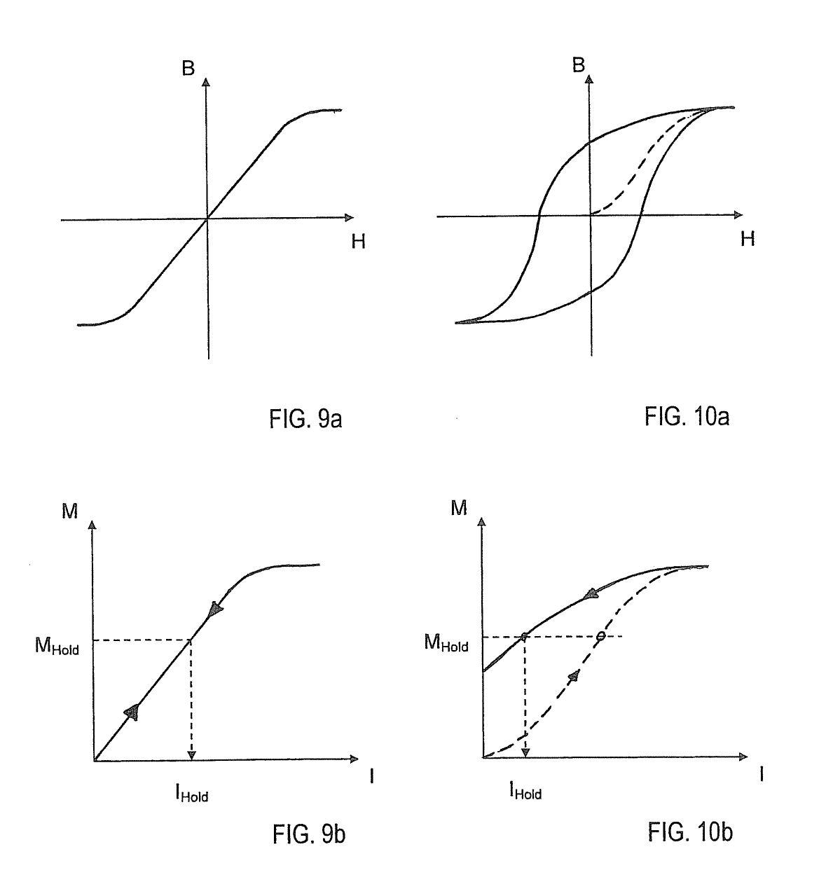

FIGS. 9a and 9b a hysteresis loop or the dependence of a transmitted torque on the coil current for a material without magnetic remanence; and

FIGS. 10a and 10b a hysteresis loop or the dependence of a transmitted torque on the coil current for a material with high magnetic remanence.

FIG. 1 shows a door brake 10 such as can be used, for example, in a vehicle door. The door brake 10 is fastened to the body, for example, using a fastening 12. A housing 16 is provided at the fastening 12 and opens upwardly. A field-generating component 18 is fixedly installed at the base therein so that a ring-shaped gap remains between the housing 16 and the field-generating component 18. It includes a coil 20 which is composed, in the example shown, of a number of coil wire groups 21 which are connected together and which are arranged in grooves in the field-generating component 18. The coil is supplied with current via the supply lines 22, 24. The fastening screw 36 with which the fastening element 12, the housing 16 and the field-generating part 18 are fixedly screwed to one another is shown only schematically.

A pot disk 26 which is connected to a fastening element 14 which is provided at a pivotable part, for example at a door, projects into the cylindrical gap between the housing 16 and the field-generating component 18. The pivotable part 14 and the fixed parts 16 and 18 are supported rotatably with respect to one another at the bearings 29 in a manner known per se. The arrangement in particular has a termination 34 with which the pivotable part 14 contacts the housing 16 sealingly, but rotatably. Reference numeral 30 designates the axis around which the pivotable element 14 is pivotable together with the pot disk 26. The pot disk 26 is supported on a slide bearing 32 in the housing 16. A rotary angle sensor 28 can be provided in the bearing 29 and serves for the measurement of the pivoting of the fastening element 14 with respect to the fixed elements 12, 16, 18.

Magnetorheological fluid 38 is located in the space between the field-generating element 18 and the housing 16.

Reference numeral 40 designates a magnetic field line indicated by way of example such as is generated by a group of coil wires 21. The other drawn groups of coil wires which produce the coil 20 overall also generate corresponding magnetic field lines. For reasons of clarity, however, not all the magnetic field lines are drawn around the groups 21.

Both the field-generating element 18 and the housing 16 are made from magnetizable material with high saturation remanence and a small hysteresis curve. Such a material is, for example, a heat-treated steel V155 of the company Böhler Edelstahl GmbH & Co. KG, Kapfenberg (Austria).

An embodiment in accordance with FIG. 1 is used as follows. The pivotable fastening element 14 is connected, for example, to a vehicle door, while the fixed fastening element 12 is fastened to the body. The vehicle door is assumed to be closed initially. No current is being applied to the current leads 22 of the coil 20. The vehicle door is now opened, for example. In the opened state, a current is applied via the current lead 22 to the coil 20 and generates a magnetic field such as is marked by the reference numeral 40 by way of example at the wire winding group 21. The parts conducting the magnetic field, in particular the field-generating component 18 and the housing 16, are magnetized. In this respect, a substantially complete magnetization of the field-generating component 18 and of the housing 16 preferably takes place (reaching the saturation magnetization). The resulting magnetic field hardens the magnetorheological fluid 38. The magnetic field generated by the coil 20 can then be switched off. Nevertheless, a magnetic field which keeps the magnetorheological fluid in a hardened state is maintained at the location of the magnetorheological fluid 38 by the magnetization of the field-generating element 18 and of the housing 16. The vehicle door is therefore kept in the open state.

Alternatively or additionally to a complete switching of the magnetic field generated by the coil 20 (current strength zero), an only reduced current strength can also selectively be set which is, however, larger than zero. An operational connection between the pot disk 26, on the one hand, and the housing 16 and the field-generating component 18, on the other hand, is hereby maintained with a low holding current and thus with a low current consumption, said operational connection being stronger than with a current strength of zero and being considerably stronger than on the setting of the same current strength when using a non-remanent material.

In both cases, the holding force which results from the remanent magnetization of the housing 16 and of the field-generating component 18 and from the operational connection to the pot disk 26 caused hereby must be reduced for the closing of the vehicle door. For this purpose, the coil 20 first has a current flow such that the magnetic field active at the location of the magnetorheological fluid 38 is reduced by generation of the required coercive field strength in the magnetizable component and remains reduced until the door is latched in accordance with its purpose, i.e. the coil initially still remains under current. The door is then held in the closed state by the lock catch. By a subsequent generation of an alternating field of reducing strength, which can be generated, for example, by applying an AC current of reducing strength to the coil 20, as is shown schematically in FIG. 8, the magnetization of the field-generating component 18 and of the housing 16 is successively reduced, as is shown in the sequence a to e on the hysteresis curve of FIG. 7. The door can now be opened at any time by unlatching the lock latch without any with a flow of current to the coil 20 being required for this purpose.

FIG. 7 in this respect shows a hysteresis loop 120 known per se with an initial magnetization curve 122. The vertical axis shows the magnetic induction B and the horizontal axis reproduces the field strength H of the applied magnetic field. The magnetic induction B ultimately corresponds to the sum of the externally applied magnetic field and of the magnetic field resulting from the magnetization. The axis section on the vertical axis indicates the saturation remanence while the axis section on the horizontal axis corresponds to the coercive force. Soft magnetic materials are characterized by a small coercive force. Heat-treated steel V155 of the company of Böhler e.g. has a correspondingly small hysteresis loop.

The curve a, b, c, d, e is e.g. moved through for the demagnetization in an aspect of the method in accordance with the invention. A substantially demagnetized state can be achieved in this manner. A possibly remaining small residual magnetization which cannot be cancelled in this manner is harmless when it is selected to be so small that the viscosity of the magnetorheological fluid in the magnetic field of the magnetizable component is only insignificantly increased with respect to the magnetic field free case.

A demagnetization of the magnetizable components, in this embodiment that is the field-generating element 18 and the housing 16, which is as complete as possible has the result that a magnetic field is no longer effective at the location of the magnetorheological fluid 38 and in this respect the pot disk 26 is no longer held in the magnetorheological field 38. A free movement of the pivotable fastening element 14 is then possible.

FIGS. 9 and 10 illustrate the utilization explained above of the hysteresis of a magnetizable component with remanence (e.g. housing 16 and field-generating element 18) for the reduction of the holding current. FIG. 9a shows a hysteresis loop (magnetic induction B over the magnetic field strength H). FIG. 9b shows the evolution of a torque M transmitted between the first element (e.g. 26) and the second element (e.g. 16, 18) over the current strength I of the current conducted through the coil. The material used in connection with FIGS. 9a and 9b here, however, dos not have any remanence at all (saturation remanence of substantially zero). The hysteresis loop in accordance with FIG. 9a thus has a width of substantially zero, i.e. the coercive field strength is substantially zero. To apply a holding torque M_{Hold}, a holding current I_{Hold} has to be conducted through the coil, cf. FIG. 9b.

FIGS. 10a and 10b likewise show a hysteresis loop and the generated torque M in dependence on the coil current I; here, however, for a magnetizable component with high saturation remanence (vertical axial section in FIG. 10a). After a complete magnetization of the magnetizable component, a holding current I_{Hold} much reduced with respect to the holding current I_{Hold} of FIG. 9b is required for the maintenance of a holding torque M_{Hold}, cf. FIG. 10b.

FIG. 2 shows a second embodiment which represents a modification of the first embodiment. In particular a second pot disk 27 is here connected to the pivotable fastening element 14 and likewise rotates with the pivotable part 14 and is supported on a second sliding bearing 33 in the housing 16. A pot disk 25 fixedly connected to the fixed fastening element 12 projects upwardly between these pot disks 26, 27.

The operation of the second embodiment is similar to the operation of the first embodiment. However, due to the multiply mutually engaging pot disks 25, 26, 27, the holding effect is increased which is exerted onto the pot disks by the magnetorheological fluid. The number of the mutually engaging pot disks is not restricted to the three pot disks shown.

The coil can e.g. also be provided in or around the housing 16 in both the first embodiment and in the second embodiment.

A third embodiment is shown in FIG. 3 which enables a linear movement 64 of two elements 52, 54 with respect to one another. The cylinder/piston arrangement 50 has a cylinder 52 and a piston 54 running in it. The piston rod of the piston 54 is movably sealed at a seal 60 in the cylinder 52. In this embodiment, coil windings 56 are provided in the piston 54 which are connected to power supply wires 58. A magnetic field can be generated by the coil 56 and is shown by way of example by the magnetic field line 62. Both the piston 54 and the cylinder 52 comprise magnetizable material of high remanence and low coercive force, that is a small hysteresis curve, such as heat-treated steel VI55 of the company of Böhler.

It is alternatively possible that the coil is not provided in the piston 54, but rather in or around the cylinder 52.

The cylinder/piston arrangement 50 can be used as follows. First, the cylinder 52 and the piston 54 are demagnetized. The piston 54 can be moved freely in the magnetorheological fluid 66. The piston can be moved to the right in FIG. 3, for example. Applying a current to the coil 56 generates a magnetic field such as is shown by way of example by the line 62 and which results in the magnetization of the cylinder 52 and of the piston 54. The magnetorheological fluid in the narrow ring-shaped region 67 between the side surface of the piston 54 and the cylinder 52 hardens so that the ring-shaped passage 67 is blocked with respect to a passage of the fluid 66 and the piston 54 is thus held in the cylinder 52. The coil 56 can now again be switched currentless or a lower current strength is set than during the magnetization. In the last-named case, a comparatively high holding force is achieved with a low current consumption.

The cylinder 52 and the piston 54 are largely demagnetized by demagnetization of the magnetic material of the piston 54 and of the cylinder 52, for example by a flow of current to the coil 56 in accordance with the diagram of FIG. 8. A magnetic field is no loner maintained at the location of the magnetorheological fluid, in particular in the ring-shaped passage 67, so that the magnetorheological fluid 66 is further liquefied. The piston 54 can again move freely in the cylinder 52.

A possible application of the third embodiment is given, for example, in a holding-open system for a vehicle door. The piston rod of the piston 54 can be connected to a vehicle door for example, while the cylinder 52 is connected to the body.

FIGS. 4 and 5 show a fourth embodiment. A piston/cylinder arrangement 70 is also realized here. A piston 78 runs in the direction 80 in a vessel 74. A further piston 76 is thus connected in a manner not shown either outside the vessel 74 or by a rigid connection within the vessel 74. The vessel 74 is rotationally symmetrical to an axis parallel to the direction of movement 80 in the embodiment shown. A narrowed region which forms a passage 82 is located at the middle. A magnetorheological fluid 84 is located in the space which is formed by the vessel 74 and the piston 78, 76. A yoke 72 of a magnetic material of high remanence, for example heat-treated steel V155 of the company of Böhler, is located in the region of the passage 82.

FIG. 5 shows a section through the arrangement of FIG. 4, as is marked by V there. IV designates the direction of view of the section visible in FIG. 4. It can be recognized in FIG. 5 that the yoke 72 terminates at the side disposed opposite the passage 82. The yoke 72 is there unwound from the winding of a coil 90 which can be supplied with power via lines 88. On a flow of current, the magnetizable material of the yoke 72 is magnetized. This magnetization results in a magnetic field 86 in the region of the passage 82 which results in a hardening of the magnetorheological fluid 84.

The fourth embodiment can be used as follows: The yoke 72 is initially not magnetized. The magnetorheological fluid 84 can flow freely through the passage 82. The pistons 76, 78 are movable freely, but together.

Applying a current to the coil 90 generates a magnetization in the yoke 72. The magnetization results in a magnetic field 86 in the region of the passage 82. The magnetorheological fluid 84 is hardened in the region of the passage 82 by this magnetic field and the free movement of the pistons 76, 78 is suppressed.

Applying current to the coil 90 with an AC current of reducing strength, such as is shown in FIG. 8, results in the demagnetization of the yoke 72. The magnetorheological fluid 84 is liquid again in the region of the passage 82 so that a free movement of the pistons 76, 78 again becomes possible.

Similar to the embodiment of FIG. 3, this embodiment can also be used to hold a door open.

FIG. 6 shows a fifth embodiment of a component assembly in accordance with the invention which can likewise serve as a door brake 100. A rotor 104 which is supported on a journaling pin 114 is rotatably journaled in a housing 102. The housing 102 can, for example, be fastened to the body of a vehicle and the rotor 104 to the door. The rotor is rotatable around the axis 112 and is sealed with respect to the housing 102 at the seal 116. Magnetorheological fluid 118 is located between the rotor 104 and the housing 102. A coil 106 which can be supplied with current via the supply line 110 is arranged in the rotor 104. If current is sent through the coil 106, a magnetic field is created which acts for the magnetization of the rotor 104 and of the vessel 102 which are manufactured from easily magnetizable material of high remanence, for example heat-treated steel V155 of the company of Böhler. A magnetic field line 108 is indicated by way of example.

After switching of the coil current, a magnetic field remains on the basis of the magnetization of the rotor 104 and of the vessel 102, whereby the magnetorheological fluid 118 remains hardened, such as has already been described with reference to the example of FIGS. 1 and 2. Equally, a comparably high holding torque can be set with low energy consumption in that the coil current is not completely switched off, but is rather set to a value which is smaller than the current strength on the magnetization of the rotor 104 and of the vessel 102, but greater than zero.

The described embodiments are characterized in that a proportion of the parts conducting the magnetic field which is as large as possible is made in each case from material of high remanence that, on the other hand, has a small hysteresis curve, that is it is in particular soft magnetic.

The described embodiments use a magnetorheological fluid. Corresponding aspects are, however, also possible when a magnetic powder is used which hardens on application of a magnetic field and thus enables a power transmission between two elements.

### REFERENCE NUMERAL LIST

10 door brake
12 fastening for a frame
14 fastening for a door
16 housing
18 field-generating component
20 coil
21 group of coil wires
22, 24 power supply of the coil
25, 26, 27 pot disk
28 rotary angle sensor
29 bearing
30 axis of rotation
32, 33 slide bearing
34 sealing rotational closure
36 fastening screw
38 magnetorheological fluid
40 magnetic field line
50 cylinder/piston arrangement
52 cylinder
54 piston
56 coil
58 power feed
60 seal
62 magnetic field line
64 direction of movement
66 magnetorheological fluid
67 ring-shaped area
70 cylinder/piston arrangement
72 yoke
74 housing
76 first piston
78 second piston
80 direction of movement
82 passage
84 magnetorheological fluid
86 magnetic field line
88 power feed
90 coil
100 door brake
102 housing
104 field-generating component
106 coil
108 magnetic field line
110 power feed
112 axis of rotation
114 bearing pin
116 seal
118 magnetorheological fluid
120 hysteresis loop
122 initial magnetization curve

1. A component assembly with a holding function comprising:
at least one first element and at least one second element which are arranged movably with respect to one another;
at least one magnetizable component with remanent properties;
a magnetorheological fluid or a magnetic powder which is located in a magnetic field of the at least one magnetizable component, when it is magnetized, and via which the two elements can be brought into operational connection; and
at least one coil which is arranged such that, with a flow of current, it can generate the magnetic field for the magnetization of the at least one magnetizable component, wherein the coil and the at least one magnetizable component cooperate such that a first currentless state can be generated in which the magnetizable component provides the magnetic field after its magnetization which is sufficient for the maintenance of the operational connection with the help of the magnetorheological fluid or of the magnetic powder, and a second currentless state can be generated in which the magnetizable component is again substantially demagnetized, whereby the operational connection between the first element and the second element can be cancelled.

2. The component assembly in accordance with claim 1, having a power supply for the coil for the generation of the magnetic field sufficient for the magnetization of the magnetizable component and having a control device for the power supply which is made for a flow of current to the coil for the generation of a magnetic alternating field with a strength reducing over time.

3. The component assembly in accordance with claim 1, wherein the first element and the second element are supported rotatably or pivotably with respect to one another.

4. The component assembly in accordance with claim 1, wherein the first element and the second element are displaceable with respect to one another.

5. The component assembly in accordance with claim 1, wherein the magnetorheological fluid or the magnetic powder is located between the first element and the second element.

6. The component assembly in accordance with claim 1, wherein the first element is designed to hold the magnetorheological fluid or the magnetic powder and the second element dips at least partly into the magnetorheological fluid or into the magnetic powder.

7. The component assembly in accordance with claim 6, wherein the first element or the second element includes the at least one magnetizable component.

8. The component assembly in accordance with claim 1, wherein the first element and the second element include the at least one magnetizable component.

9. The component assembly in accordance with claim 1, wherein a current strength of the coil current is set in a first current flow state of the coil which is lower than a current strength set for the magnetization of the magnetizable component and is larger than zero.

10. The component assembly in accordance with claim 1, wherein the at least one magnetizable component has a coercive field strength in the range from approximately 10³ to 10⁴ A/m.

11. The component assembly in accordance with claim 1, wherein the at least one magnetizable component has a remanence in the region of approximately 0.5 to 2 T.

12. The holding-open system having the component assembly in accordance with claim 1 for a door or flap which is pivotably connected to a holder fixed relative thereto, wherein either the first element or the second element moves at least indirectly with the door or the flap and the other element is fastened to the fixed holder.

13. The holding-open system in accordance with claim 12, wherein the first element is located at the fixed holder.

14. The holding-open system in accordance with claim 12, wherein the component assembly is a hinge or is comprised by a hinge.

15-20. (canceled)

21. A component assembly with a holding function comprising:
a first element and a second element which are arranged movably with respect to one another;
a magnetizeable component with remanent properties;
a magnetorheological fluid or a magnetic powder which is located in a magnetic field of the magnetizeable component, when it is magnetized, and via which the first and second elements can be brought into an operational connection; and
a coil which is arranged such that, with a flow of current, it can generate the magnetic field for the magnetization of the magnetizeable component, wherein the coil and the magnetizeable component cooperate such that a first state can be generated in which the magnetizeable component provides the magnetic field after its magnetization which is sufficient for the maintenance of the operational connection with the help of the magnetorheological fluid or of the magnetic powder, wherein a second state can be generated in which the magnetizeable component is again substantially demagnetized such that the operational connection between the first element and the second element can be cancelled, and wherein the current strength of the coil current is set in the first state to be less than the current strength set for magnetization of the magnetizeable component and greater than zero.

22. The component assembly in accordance with claim 21 having a power supply for the coil for the generation of the magnetic field sufficient for the magnetization of the magnetizeable component and having a control device for the power supply which is made for a flow of current to the coil for the generation of a magnetic alternating field with a strength reducing over time.

23. The component assembly in accordance with claim 21, wherein the first element and the second element are supported rotatably or pivotably with respect to one another.

24. The component assembly in accordance with claim 21, wherein the first element and the second element are displaceable with respect to one another.

25. The component assembly in accordance with claim 21, wherein the magnetorheological fluid or the magnetic powder is located between the first element and the second element.

26. The component assembly in accordance with claim 21, wherein the first element is designed to hold the magnetorheological fluid or the magnetic powder and the second element dips at least partly into the magnetorheological fluid or into the magnetic powder.

27. The component assembly in accordance with claim 21, wherein the first element or the second element includes the at least one magnetizeable component.

28. The component assembly in accordance with claim 21, wherein the first element and the second element include the at least one magnetizeable component.

29. A method of operating a component assembly comprising the steps of:
providing a component assembly with a holding function including a first element and a second element which are arranged movably with respect to one another, a magnetizeable component with remanent properties, a magnetorheological fluid or a magnetic powder which is located in a magnetic field of the magnetizeable component, when it is magnetized, and via which the first and second elements can be brought into operational connection, and a coil capable of generating the magnetic field for the magnetization of the magnetizeable component;
setting a first relative position of the first element and the second element;
applying current to the coil for generating the magnetic field to magnetize the magnetizeable component and increase the viscosity for hardening of the magnetorheological fluid or magnetic powder; and
switching off the current in the coil while the magnetization of the magnetizeable component is maintained, whereby a first state is generated upon magnetization of the magnetizeable component which functions to maintain an operational connection between the first and second elements in the first relative position.

30. The method of claim 29 further including the step of generating a second state in which the magnetizeable component is substantially demagnetized so as to release the operational connection between the first and second elements in the first relative position.

31. The method of claim 30 wherein the step of setting the first relative position of the first and second elements occurs when the first element is a door or flap and the second element is a fixed holder, and wherein the door or flap is open relative to the fixed holder.

32. The method of claim 30 further including the step of demagnetizing the magnetizeable component by applying current to the coil having a strength value reducing over time so as to release the operational connection between the first and second elements in the first relative position.

33. The method of claim 31 further including the step of setting a second relative position between the first and second elements.

34. The method of claim 33 wherein the step of setting the second relative position between the first and second elements is carried out before the step of demagnetizing the magnetizeable component.

35. The method of claim 33 wherein the step of setting the second relative position between the first and second elements is carried out prior to the step of demagnetizing the magnetizeable component.

36. The method of claim 32 further including the step of providing continuous current flow to the coil such that the magnetic field effective at the location of said magnetorheological fluid or magnetic powder is substantially cancelled.

37. The method of claim 36 wherein the step of providing continuous current flow to the coil occurs prior to the step of demagnetizing the magnetizeable component.

38. The method of claim 30 wherein the first state is a first currentless state and wherein the second state is a second currentless state.

39. The method of claim 30 wherein the first state is a low current flow state generated by reducing the current in the coil instead of switching off the current.
